(19) United States
(12) Patent Application Publication
(10) Pub. No.: US 2025/0175236 A1
(43) Pub. Date: May 29, 2025

(54) Optimized Beam Search and Alignment in Directive Systems

(71) Applicant: Apple Inc., Cupertino, CA (US)

(72) Inventors: Stefan Meyer, Munich (DE); Biljana Badic, Munich (DE); Christian Drewes, Germering (DE); Jan K Ellenbeck, Gruenwald (DE); Mikhail Wilhelm, Munich (DE); Norman Goris, Dortmund (DE)

(21) Appl. No.: 18/959,334

(22) Filed: Nov. 25, 2024

Related U.S. Application Data
(60) Provisional application No. 63/603,029, filed on Nov. 27, 2023.

(51) Int. Cl. H04B 7/06; H04B 7/08; H04L 1/00

(52) U.S. Cl. CPC H04B 7/06958; H04B 7/086; H04L 1/0013

(57) ABSTRACT

Disclosed are methods, systems, and computer-readable medium to perform operations including: receiving, from a device, a beacon request; generating a transmission beacon pattern associated with the beacon request; transmitting a plurality of beams according to the transmission beacon pattern; receiving a message that identifies one or more strongest transmission beams of the plurality of beams; generating a reception beacon pattern associated with the beacon request; transmitting the one or more strongest transmission beams according to the reception beacon pattern; and communicating, with the device, using at least one of the one or more strongest transmission beams and a reception beam of the device.

### CROSS-REFERENCE TO RELATED APPLICATION

This application claims the benefit of U.S. Provisional Application No. 63/603,029, filed Nov. 27, 2023, the contents of which are incorporated by reference herein.

### BACKGROUND

Wireless communication networks provide integrated communication platforms and telecommunication services to wireless user devices. Example telecommunication services include telephony, data (e.g., voice, audio, and/or video data), messaging, and/or other services. The wireless communication networks have wireless access nodes that exchange wireless signals with the wireless user devices using wireless network protocols, such as protocols described in various telecommunication standards promulgated by the Third Generation Partnership Project (3GPP) or the Institute of Electrical and Electronics Engineers (IEEE). Example wireless communication networks include time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

### SUMMARY

In accordance with some aspects of the present disclosure, receiving, from a device, a beacon request; generating a transmission beacon pattern associated with the beacon request; transmitting a plurality of beams according to the transmission beacon pattern; receiving a message that identifies one or more strongest transmission beams of the plurality of beams; generating a reception beacon pattern associated with the beacon request; transmitting the one or more strongest transmission beams according to the reception beacon pattern; and communicating, with the device, using at least one of the one or more strongest transmission beams and a reception beam of the device.

In accordance with some aspects of the present disclosure, transmitting, to an access point, a beacon request; receiving first data identifying a transmission beacon pattern associated with the beacon request; selecting, from a plurality of beams transmitted according to the transmission beacon pattern, one or more strongest transmission beams; transmitting, to an access point, data identifying the one or more strongest transmission beams; based at least on transmitting the data identifying the one or more strongest transmission beams, receiving second data identifying a reception beacon pattern associated with the beacon request; selecting, based at least on transmission of the one or more strongest transmission beams according to the reception beacon pattern, a reception beam; and communicating, with the access point, using at least one of the one or more strongest transmission beams and the reception beam.

A system can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. The operations or actions performed either by the system or by the instructions executed by data processing apparatus can include the methods described above.

The foregoing and other implementations can each optionally include one or more of the following features, alone or in combination. Receiving the beacon request can be performed using an omni-directional radio access technology. Transmitting the plurality of beams and the one or more strongest transmission beams can be performed using a directional radio access technology.

In some implementations, the method can include transmitting, to the device, the transmission beacon pattern or the reception beacon pattern using an omni-directional radio access technology.

In some implementations, the transmission beacon pattern can be generated based on an item of information associated with the device.

In some implementations, the method can include receiving, from each device in a plurality of devices including the device, a corresponding beacon request that comprises information associated with the corresponding device. The transmission beacon pattern can be generated using information associated with two or more devices in the plurality of devices.

In some implementations, the reception beacon pattern can be generated based on an item of information associated with the device.

In some implementations, the method can include generating a beacon pattern can include identifying a gap in scheduled data communications. Transmitting a beam according to the transmission beacon pattern or the reception beacon pattern can include puncturing or rate matching around the scheduled data communications for a beacon reference signal transmission.

In some implementations, the transmission beacon pattern associated with the beacon request can include a defined start point. Transmitting the plurality of beams can include transmitting a first beam of the plurality of beams in accordance with the defined start point.

In some implementations, generating the reception beacon pattern can include generating a beacon pattern for the device to select a corresponding reception beam and a second, different device to select one or more strongest transmission beams.

In some implementations, the method can include, while communicating with the device: determining whether to adjust a transmission beam for the communication with the device; and selectively adjusting the transmission beam or determining to skip adjusting the transmission beam based at least in part on a result of the determination of whether to adjust the transmission beam for the communication with the device.

In some implementations, the reception beam associated with the device can be based at least on the reception beacon pattern.

In some implementations, transmitting the beacon request can be performed using an omni-directional radio access technology. Selecting the one or more strongest transmission beams and selecting the reception beam can be performed using a directional radio access technology.

In some implementations, the method can include, while communicating with the access point: determining whether to adjust a reception beam associated with the communication with the access point; and selectively adjusting the reception beam or determining to skip adjusting the reception beam based on a result of the determination of whether to adjust the reception beam associated with the communication with the access point.

In some implementations, the method can include determining a cadence with which to determine whether to adjust the reception beam associated with the communication with the access point.

In some implementations, the cadence can be determined based at least on one or more of device movement data, device rotation data, a prior beam variation rate, or a signal quality.

In some implementations, transmitting the beacon request can include transmitting, by a wireless device and to the access point, the beacon request.

The subject matter described in this specification can be implemented in various implementations and may result in one or more of the following advantages. In some implementations, the systems and methods described in this specification only send access point (“AP”) beacon beams when requested and required reducing computational resource usage, e.g., using resources and power only when needed. In some implementations, the systems and methods described in this specification can tailor dynamic on demand beacon beams to be combined with data-transmission to improve the high directivity of the systems, e.g., beacon beams can be sent in one direction while the data-transmission is going into another direction. In some implementations, this can optimally deploy the high directivity of the system. In some implementations, the systems and methods described in this specification might not require additional frequency resources, additional time resources, or both, for beam search and alignment during an ongoing data connection. This can improve the relation between reference signals and data signals, e.g., enabling transmission of more data. In some implementations, the systems and methods described in this specification can improve frequency, time, or both, utilization for the pure data-transmission, e.g., improving the spectral efficiency, reducing power consumption per transmitted data bit, or both.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates an example wireless network, according to some implementations.

FIGS. 2A-B and 3 depict an example environment in which two devices perform a transmission (“Tx”) beam search, beam refinement, or both, procedure for a directional radio access technology (“RAT”).

FIG. 4 depicts an example environment in which two devices perform a reception (“Rx”) beam search, beam refinement, or both, procedure for a directional radio access technology (“RAT”).

FIG. 5 depicts example beacon patterns.

FIG. 6 depicts examples of beam alignment processes during data transmission.

FIG. 7 depicts an example environment in which a data connection includes multiple reference signals.

FIG. 8 illustrates a flowchart of an example method for using a beacon pattern, according to some implementations.

FIG. 9 illustrates an example user equipment (UE), according to some implementations.

FIG. 10 illustrates an example access node, according to some implementations.

### DETAILED DESCRIPTION

Various wireless communication protocols use different types of beam searching. For instance, some systems can use constant access point (“AP”) beacon beams for AP discovery and initial beam alignment. For user equipment (“UE”) beam alignment, the UE can send a set of beams to the AP for beam measurements to align the starting point for data transmission. Some communication protocols can allow additional beam measurements during data transmission via dedicated beam measurement resources in downlink (“DL”), e.g., AP pilots, and uplink (“UL”), e.g., UE SRS. Some communication protocols use a one-to-one connection in stationary conditions such that beam search and alignment is just a one-time activity, e.g., beam search and beacon beams are stopped after the initial connection has been set up.

Some communication protocols use a predetermined quantity of beams, e.g., all beams, sent with a fixed, predefined repetition period. The beams can be sent according to a fixed, predetermined beacon pattern that does not change with changing conditions. These communication protocols use dedicated resources, e.g., CSI-RS and SRS, to constantly align UE and AP beams during ongoing data transmission.

Wireless devices can connect to a network using a base station, e.g., when the wireless device is a user equipment (“UE”), or another type of access point, such as a wireless router. The wireless device can use sub-terahertz (“sub-THz”) frequency range to communicate with the access point, e.g., for 6G communication. The sub-THz frequency range provides large bandwidths enabling transmission of hundreds of Gbps with simple modulations, higher privacy level due to the spatial directivity required in sub-THz systems, e.g., making eavesdropping much harder compared to omni-directional systems, or a combination of both. However, the sub-THz frequency range might introduce additional complexity compared to an omni-directional system. For instance, sub-THz frequency range might require new hardware and power amplifier (“PA”) technology to enable the high required frequency. In some implementations, sub-THz frequency wireless devices might have high path loss, e.g., in indoor use-cases with limited range and dominant line of sight (“LOS”) paths.

Further, sub-THz frequency range communications can require small beams for directive radio access technologies (“RATs”). Some examples of RATs include Bluetooth, Wi-Fi, and GSM, UMTS, LTE or 5G NR. As a result of the small beams, a beam search process consumes a greater amount of resources compared to other systems. For instance, use of small beams for directive RATs can have certain implications for the access to the channel and handling of data-transfer on the channel, e.g., leading to increased power, increased frequency and/or time resource consumption, or both, in order to handle small beams compared to other systems. One implication can include complicated beam searches between the AP and wireless device. One implication can include beam tracking complexity that increases, e.g., scales, with the number of beams to be handled. One implication can require procedures to handle beam recovery, e.g., requiring complicated feedback mechanism. One implication can require a lot of frequency and time resources for beam search and alignment, e.g., due to the greater number of beams for sub-THz compared to other systems, that can't be used for data-transmission. One implication can be that the AP, in a continuous mode, might constantly send beacon signals and thus constantly consume power, create interference with other communications, or both, although such beams are only required for initial beam alignment.

A wireless device and an access point can perform an improved beam search and alignment procedure, e.g., an optimized procedure. The procedure can include the use of on demand AP beams for initial AP transmission (“Tx”) and wireless device reception (“Rx”) beam selection, e.g., replacing periodic beacon signals. The AP can combine on demand beacon signals for different wireless devices to handle parallel requests, account for position information, align requests with ongoing data transmissions, or a combination of these. These features can reduce computational resource usage.

The wireless device can request on demand beacon signals using an omni-directional RAT. The AP can then transmit the beacon signals using a directional RAT, e.g., during a data period, or gaps within the data period. Within the data period, beam alignment can be performed on small portions of the data signals. The AP can select these portions such that they satisfy a minimum duration threshold, e.g., that they are sufficiently long to allow beam switching and measurements, and satisfy a maximum duration threshold, e.g., that they are sufficiently short to have only limited impact on the data decoding. Since the AP is transmitting the beacon signals during other data transmissions, but using the maximum duration threshold, the devices can handle bit errors using the redundancy coding for the data transmissions. After the initial beam selection, the AP and wireless device can separately, e.g., autonomously, check adjacent beams during data communications for better performance and adjust, e.g., switch, beams as necessary. As a result, the AP and wireless device can require less interworking for beam alignment between the AP and the wireless device compared to other systems.

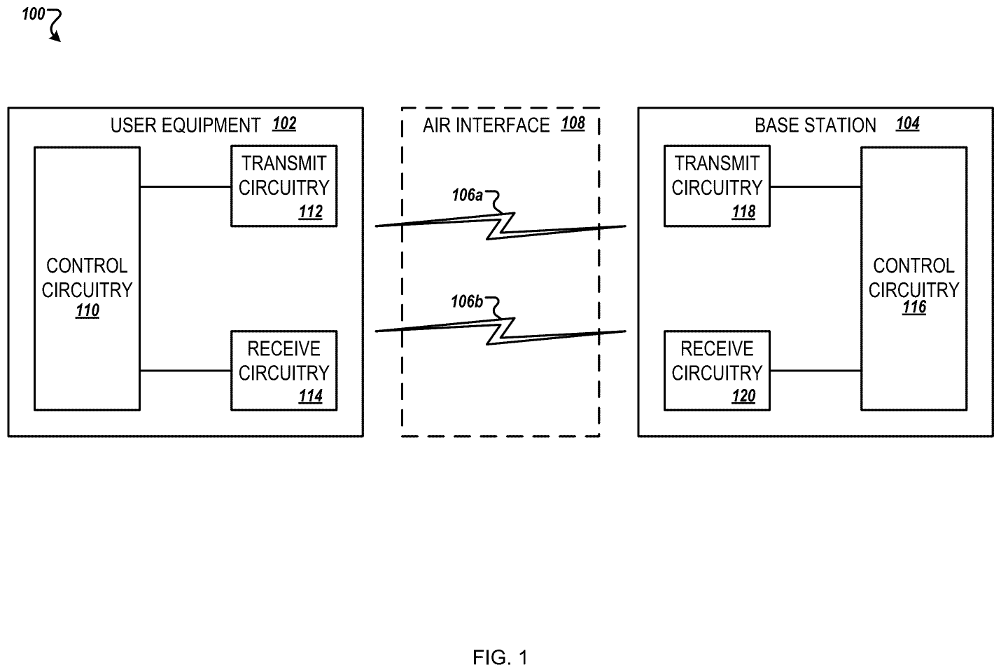

FIG. 1 illustrates an example wireless network 100, according to some implementations. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104. Although the example described with reference to FIG. 1 describes a base station 104 as an access point, the UE 102 can communicate with other types of access points, e.g., using IEEE 802 technology.

In some implementations, the wireless network 100 may be a Non-Standalone (NSA) network that incorporates Long Term Evolution (LTE) and Fifth Generation (5G) New Radio (NR) communication standards as defined by the Third Generation Partnership Project (3GPP) technical specifications. For example, the wireless network 100 may be a E-UTRA (Evolved Universal Terrestrial Radio Access)-NR Dual Connectivity (EN-DC) network, or an NR-EUTRA Dual Connectivity (NE-DC) network. In some other implementations, the wireless network 100 may be a Standalone (SA) network that incorporates only 5G NR. Furthermore, other types of communication standards are possible, including future 3GPP systems (e.g., Sixth Generation (6G)), Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, any of laptop computers, smartphones, tablet computers, machine-type devices such as smart meters or specialized devices for healthcare, intelligent transportation systems, or any other wireless device. In network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider, or may be the Internet. Each base station service area associated with the base station 104 is supported by one or more antennas integrated with the base station 104. The service areas can be divided into a number of sectors associated with one or more particular antennas. Such sectors may be physically associated with one or more fixed antennas or may be assigned to a physical area with one or more tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include various combinations of application-specific circuitry and baseband circuitry. The transmit circuitry 112 and receive circuitry 114 may be adapted to transmit and receive data, respectively, and may include radio frequency (RF) circuitry and/or front-end module (FEM) circuitry.

In various implementations, aspects of the transmit circuitry 112, receive circuitry 114, and control circuitry 110 may be integrated in various ways to implement the operations described herein. The control circuitry 110 may be adapted or configured to perform various operations, such as those described elsewhere in this disclosure related to a UE. For instance, the control circuitry 110 can cause the UE to select a strongest Tx beam from the base station 104, select a Rx beam, or both.

The transmit circuitry 112 can perform various operations described in this specification. For example, the transmit circuitry 112 can transmit a beacon request, data that identifies the strongest Tx beam, data that identifies the Rx beam, or a combination of these. Additionally, the transmit circuitry 112 may transmit using a plurality of multiplexed uplink physical channels. The plurality of uplink physical channels may be multiplexed, e.g., according to time division multiplexing (TDM) or frequency division multiplexing (FDM) along with carrier aggregation. The transmit circuitry 112 may be configured to receive block data from the control circuitry 110 for transmission across the air interface 108.

The receive circuitry 114 can perform various operations described in this specification. For instance, the receive circuitry 114 can receive downlink data, e.g., and corresponding reference signals included in the downlink data, can be used to select a strongest Tx beam, a Rx beam, or both, or a combination of two or more of these. Additionally, the receive circuitry 114 may receive a plurality of multiplexed downlink physical channels from the air interface 108 and relay the physical channels to the control circuitry 110. The plurality of downlink physical channels may be multiplexed, e.g., according to TDM or FDM along with carrier aggregation. The transmit circuitry 112 and the receive circuitry 114 may transmit and receive, respectively, both control data and content data (e.g., messages, images, video, etc.) structured within data blocks that are carried by the physical channels.

FIG. 1 also illustrates the base station 104. In some implementations, the base station 104 may be a 5G radio access network (RAN), a next generation RAN, a E-UTRAN, a non-terrestrial cell, or a legacy RAN, such as a UTRAN. As used herein, the term “5G RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108. The transmit circuitry 118 and receive circuitry 120 may be adapted to transmit and receive data, respectively, to any UE connected to the base station 104. The receive circuitry 120 may receive a plurality of uplink physical channels from one or more UEs, including the UE 102. For instance, the receive circuitry 120 can receive a beacon request, e.g., an omni-directional beacon request, data that identifies a strongest Tx beam, data that identifies a Rx beam, or a combination of these. The transmit circuitry 118 can transmit one or more Tx beams, transmit DL data to the UE 102, or a combination of both. The control circuitry 116 can cause the base station 104 to generate a beacon pattern.

In FIG. 1, the one or more channels 106A, 106B are illustrated as an air interface to enable communicative coupling, and can be consistent with cellular communications protocols, such as a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any other communications protocol(s). In implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Discovery Channel (PSDCH), and a Physical Sidelink Broadcast Channel (PSBCH).

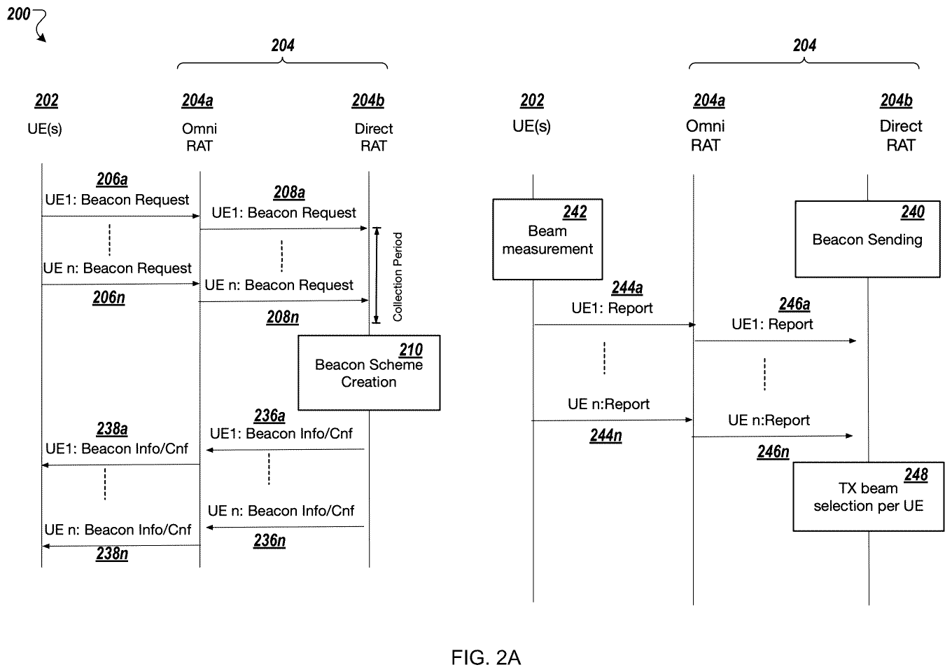

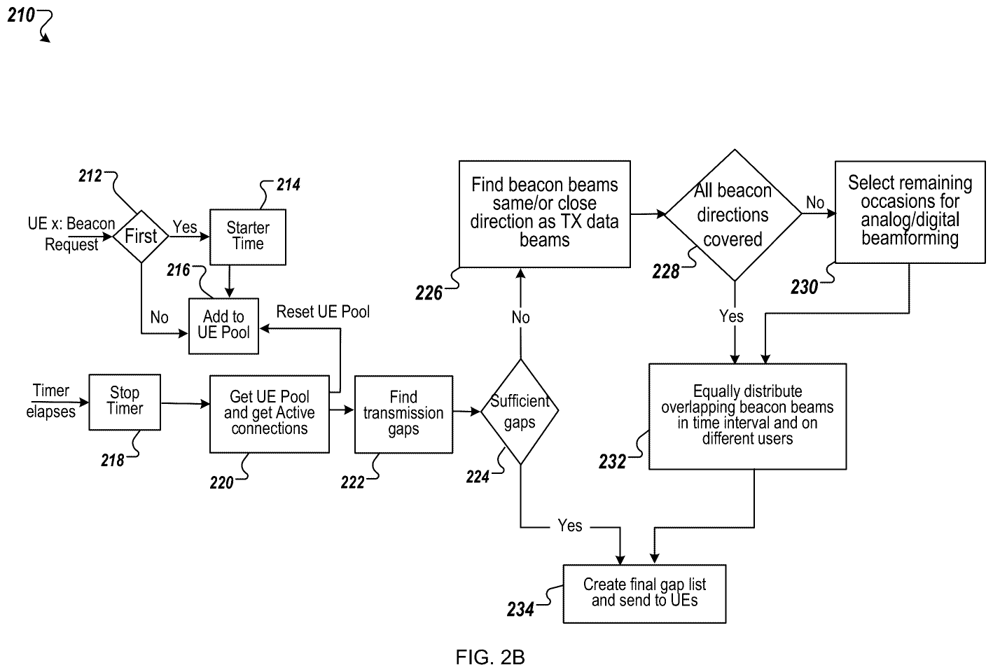

FIGS. 2A-B depict an example environment 200 in which two devices perform a transmission (“Tx”) beam search, beam refinement, or both, procedure for a directional radio access technology (“RAT”). The two devices can include a wireless device 202, e.g., a user equipment, and an access point 204. The access point can be any appropriate type of access point such as a cellular base station or an IEEE 802.11 access point, e.g., a Wi-Fi access point. One example of the wireless device includes the UE 102 described with reference to FIG. 1.

The wireless device can establish a connection with the access point (“AP”) using a two-step access procedure. For instance, the wireless device can connect to an omni-directional RAT 204a, e.g., Wi-Fi, before accessing a directional RAT 204b, e.g., sub-THz. In FIG. 2, the access procedure to the omni-directional RAT can be performed using any appropriate process and is assumed to be finished already. As a result, the wireless device is already aware of the omni-directional AP as well as the directional AP, along with associated additional parameters and timings. In order to transfer control information between wireless device and the AP, the two devices can use the omni-directional RAT, a tailored low bandwidth signal, e.g., broad beam, in the directional RAT, or a combination of both.

The omni-directional RAT 204a and the directional RAT 204b can be at any appropriate physical location with respect to each other. In some implementations, the omni-directional RAT 204a and the directional RAT 204b can be collocated, e.g., in the same AP 204. This can reduce any potential issues that might arise from transferring parameters or other types of information between the two RATs 204a-b. For instance, when the omni-directional RAT 204a and the directional RAT 204b are collocated, there need not be a wireless link between the two RATs 204a-b. In some implementations, when the two RATs 204a-b are not collocated, the omni-directional RAT 204a and the directional RAT 204b can use the omni-directional link, the directional link, or a combination of both, to communicate between each other.

After the initial registration via the omni-directional RAT, the wireless device 202 is aware of the directional RAT AP 204b. The wireless device 202 can use the directional RAT AP 204b for high-speed traffic, e.g., higher speed traffic than the omni-directional RAT AP 204a.

The wireless device 202 sends, to the omni-directional RAT AP 204a, a beacon request 206 for the AP 204 to transmit beacon beams. The omni-directional RAT AP 204a forwards the beacon request 208 to the directional RAT AP 204b. Although FIGS. 2A-B are generally described with reference to a single wireless device, and a single beacon request 206a, 208a, the AP 204 can receive requests from multiple wireless devices, e.g., requests 206a-n that are forwarded as requests 208a-n.

The beacon request 206a-n, 208a-n can include any appropriate information. For instance, the beacon request 206a-n, 208a-n can include information in addition to a beacon request. The additional information can be information about the wireless device 202, e.g., wireless device priority, wireless device capabilities, wireless device position information, wireless device direction information, or a combination of these. The AP 204 can use the additional information to optimize the sending of the beacon beams to the wireless device 202.

The AP 204 then generates a transmission beacon pattern 210, described in more detail with respect to FIG. 2B. For example, the AP 204 can determine whether the beacon request 206, 208 is the first request. The first request can be a first request within a predetermined time period, e.g., after a prior request for which the AP 204 previously determined a beacon pattern. The first request can be a first request for a direction, e.g., since the AP 204 can generate separate beacon patterns for different directions. When the beacon request 206, 208 is a first request, the AP 204 starts a timer 214. The AP 204 adds the beacon request to a wireless device pool 216, e.g., irrespective of whether the beacon request 206, 208 is a first request. By using the wireless device pool, the AP 204 can collect received beacon requests 206, 208 for a time period, e.g., with a predetermined duration, to aggregate the beacon requests from different wireless devices to a single set of beacon beams, e.g., to save time and resources.

When the timer elapses, the AP 204 can stop the timer 218. The AP 204 can retrieve data that indicates the wireless devices, or the corresponding requests, in the pool 220.

In some implementations, the AP 204 can get a list of active connections, e.g., UEs that already have data transfer with the AP 204. The data transfer can be UL, DL, or a combination of both.

The AP 204 finds transmission gaps 222 in current transmissions with other wireless devices, e.g., wireless devices that are communicating with the AP 204 and for which the AP 204 does not have a request in the pool. The other wireless devices can include devices identified by the list of active connections. The AP 204 can find the transmission gaps 222 in transmission beams that have a corresponding direction selected based on the additional information for the wireless device, e.g., wireless device priority, wireless device capabilities, wireless device position information, wireless device direction information, or a combination of these. The transmission gaps 222 can occur in loaded systems due to response latencies, feedback latencies, or a combination of both.

For instance, since the AP 204 knows the ongoing and planned wireless device data transmission, including a first data signal in direction a 302a and a second data signal in direction c 302b, shown in FIG. 3, the AP 204 can find a gap 304 between the two data signals 302a-b. The gap 304 can define a first set of resource candidates for a beacon beam 306. For instance, even during an ongoing data transmission, gaps can occur to account for round trip delays in data acknowledgment between the AP 204 and another wireless device, e.g., for which the AP 204 does not have a request in the pool.

Returning to FIG. 2B, the AP 204 can use the gaps to form a beacon pattern in which the AP 204 can transmit beacons to the wireless devices for the pool. The AP 204 can generate the transmission beacon pattern that is not longer than a defined time interval, e.g., to limit the initial access latency. The AP 204 can use the additional information, e.g., included in the beacon requests 206, 208 and for the corresponding wireless devices, to find the gaps, generate the beacon pattern, or a combination of both.

The AP 204 can determine whether a current quantity of gap-based resource candidates is sufficient 224. If not, the AP 204 can find additional resources for the beacon pattern 226. For instance, the AP 204 can find beacon beams in the same direction as the transmission data beams, in directions that are within a threshold angle of the transmission data beams, or a combination of both, for the additional resources. The AP 204 can find the additional resources from already ongoing AP transmission frames.

The AP 204 can determine whether all beacon directions, for the beacon requests in the pool, are covered. Specifically, since the AP 204 is using directional beams instead of omni-directional beams, the AP 204 can determine whether beams for a sufficient number of directions are selected given the physical locations of the wireless device 202 and the AP 204, and the likely direction between the two devices.

If all beacon directions are not covered, the AP 204 can select remaining occasions for beam forming. The remaining occasions can be digital, analog, or a combination of both. For instance, the AP 204 can select gaps that have directions given the corresponding transmissions. In case the AP 204 cannot cover a beam direction in a gap and the beam direction does not satisfy a similarity criterion for an ongoing transmission, e.g., is not close to the ongoing transmission, the AP 204 can select some other mechanism to provide a beacon in the beam direction. The AP 204 can select the other mechanism using the capabilities of the AP 204. For instance, the AP 204 can determine whether another panel is available for the beam direction, the AP 204 has the capability to do analog beam forming for the beam direction, the AP 204 has the capability to do digital beam forming for the beam direction, or a combination of these. In some implementations, the other mechanism might result in reduced signal strength for the ongoing data transmission. As a result, the AP 204 can distribute the other mechanisms between the involved wireless devices, e.g., to minimize any potential reduced signal.

If all beacon directions are covered, or after the AP 204 selects the remaining occasions, the AP 204 can distribute, e.g., equally, overlapping beacon beams in the time interval and on different wireless devices, e.g., the wireless devices for which beacon requests are not in the pool. By distributing the overlapping beacon beams on different wireless devices, the AP 204 can minimize an individual impact on the different wireless devices.

If the AP 204 determines that there are sufficient gaps 224, or once the AP distributes the overlapping beacon beams 232, the AP 204 creates a beacon pattern. For the beacon pattern, the AP 204 can create a final gap list that indicates the gaps in which the AP 204 will transmit beacons.

For the beacon pattern, the AP 204 can select beacon beams that are: 1) in the current data Tx beam, 2) within a threshold angle to the current data Tx beam, e.g., are close to the current data Tx beam, or 3) are not within the threshold angle to the current data Tx beam, e.g., are far away from the current data Tx beam. For instance, the AP 204 can have already established connections to other wireless devices. Given the beacon pattern, the AP 204 scheduler determined gaps in the communications with the other wireless devices in advance. For instance, the beacon pattern can indicate a wireless device for which there is an existing connection and a time slot, frequency resource, or both, for the gap. The beacon pattern can indicate whether the gap is for a transmission or reception signal. For a Tx signal in the beacon pattern, when the AP 204 determines that the time slot for that Tx signal is satisfied, the AP 204 can select the current data Tx beam as the Tx beam for the determined Tx signal with the time slot that is satisfied, e.g., the term current data Tx beam can correspond to the Tx beam as selected by the AP 204 scheduler for the given time-instance for a data transmission from AP to wireless device. In some implementations, for a given time-instance, a wireless device to AP transmission might be scheduled and thus no AP Tx beam is valid.

When the beacon beam is the current data Tx beam, the beacon reference signals can replace the current data symbols for a short amount, e.g., less than 10%, of time and frequency. The AP 204 can puncture the data symbols for the beacon reference signal transmissions. In some implementations, rate matching around the reference signals is possible. The AP 204 can use additional signaling of the reference signal location and timing towards the wireless device 204 for RAT matching.

When the beacon beam is within the threshold angle to the current data Tx beam, the beacon reference signals can replace the current data symbols for a short amount, e.g., less than 10%, of time and frequency. The AP 204 can adapt the current data Tx beam to match the wanted beacon beam. This can reduce an amount of degradation of the current data Tx beam given the close proximity between both beams.

When the beacon beam is not within the threshold angle to the current data Tx beam, the AP 204 can use digital or analog beam forming depending on its capabilities.

For analog beam-forming with a single panel, the AP 204 can send the same input stream into two different directions. The AP 204 can use puncturing of data signal with reference signals for beacon required. This can result in loss in signal strength. For analog beam forming with a dual panel, the AP can use a different input stream per panel, e.g., the AP 204 need not puncture the data signal. This can result in the loss in signal strength split between the two streams. For digital beam forming with a single panel, the AP 204 can use two input streams per panel, e.g., without puncturing of data signal. This can result in loss in signal strength. The AP can use beam forming to select the beam directions to reduce an amount of interference, e.g., to ensure a minimum interference, e.g., maximum spatial distance.

As shown in FIG. 3, the AP 204 can use a different frequency portion (“FD”) for a single beam 308, use two parallel beams 310, e.g., in spatial separation, or use a slightly bent beam and FD 312. The AP 204 can place the resources used for the parallel transmission 310 around the gap-based resources, e.g., to improve even time distribution within the beacon period for a beacon pattern. This can ensure an even time distribution within the beacon period. In some implementations, the AP 204 can distribute, e.g., evenly, the additional resources between the scheduled wireless devices, e.g., for which corresponding requests are not in the pool, to minimize an impact, e.g., quality loss, on communications with any single wireless device. In some implementations, the AP 204 can use a priority for a wireless device, if available, when selecting the resources.

Returning to FIG. 2A, to create a beam pattern 236a-n, e.g., an optimized beam pattern, the AP 204 can combine two or more of the above described mechanisms. The AP 204 can generate the beam pattern 236a-n that has reduced, e.g., the least, interference for a single wireless device, a low, e.g., lowest, power consumption, an optimized frequency and time usage, or a combination of these. The AP 204 then sends the beacon beam pattern 236a-n in time and frequency to the wireless devices 202, e.g., that have corresponding requests in the pool. The AP can send the beacon beam pattern 236a-n via the directional RAT AP 204b to the omni-directional RAT AP 204a. The omni-directional RAT AP 204a can forward the beacon beam pattern 238a-n to the wireless devices 202. The AP can send the same beacon beam pattern 236, 238 to all wireless devices 202, e.g., to reduce an amount of resources required by using the same pattern for multiple wireless devices. The wireless device 202 confirms the received pattern, e.g., by sending a confirmation message to the AP 204.

The beam pattern 236, 238 can include a defined start point. At the defined start point, the AP 204 starts transmitting beacons 240 according to the beacon beam pattern 236, 238.

During transmission of beacons according to the beacon beam pattern 236, 238, e.g., during the beacon period, the wireless device 202 measures the Tx beams of the AP. The wireless device 202 can determine one or more strongest strength Tx candidates, e.g., as detected by the wireless device 202. The wireless device 202 can use any appropriate process to determine the one or more strongest strength Tx candidates.

The wireless device 202 can report 244a-n information about the strongest strength Tx candidates, e.g., reports the strength of the candidates, back to the AP 204 via the omni-directional RAT AP 204a. The omni-directional RAT AP 204a can forward the report 246a-n to the directional RAT AP 204b. The AP 204 can use the information from the report 244, 246, to select a Tx beam 248, e.g., the likely best Tx beam, for communication with the wireless device 202, for wireless device Rx beam selection, or both. The AP 204 can use any appropriate process to select the Tx beam. As a result of decoupling Tx beam and Rx beam selection, the wireless device 202 does not need to perform an Rx beam sweep during the initial AP 204 Tx beacon beams transmitted as part of the Tx beam selection process.

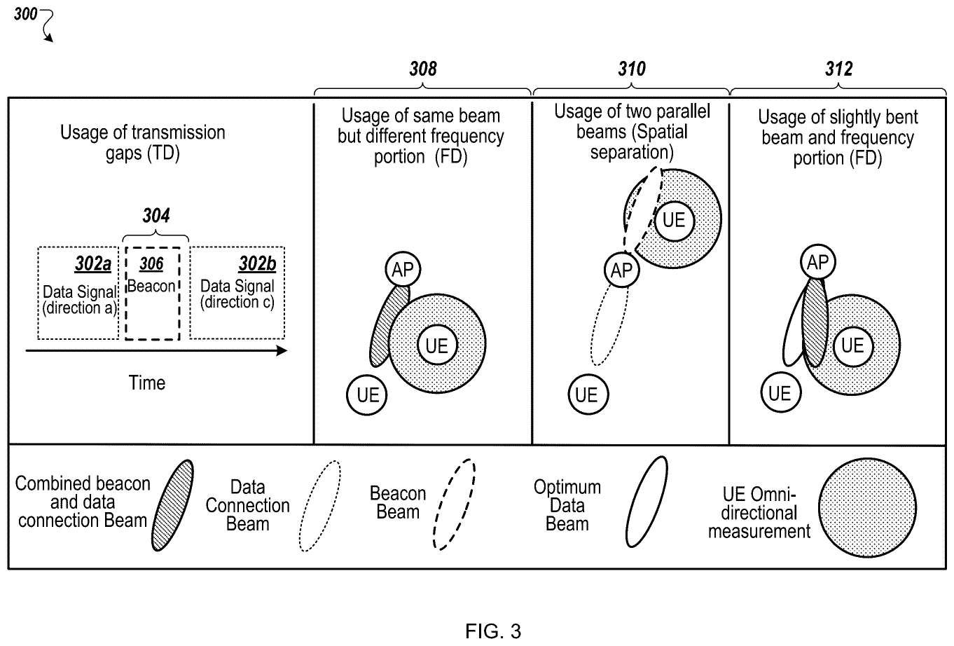

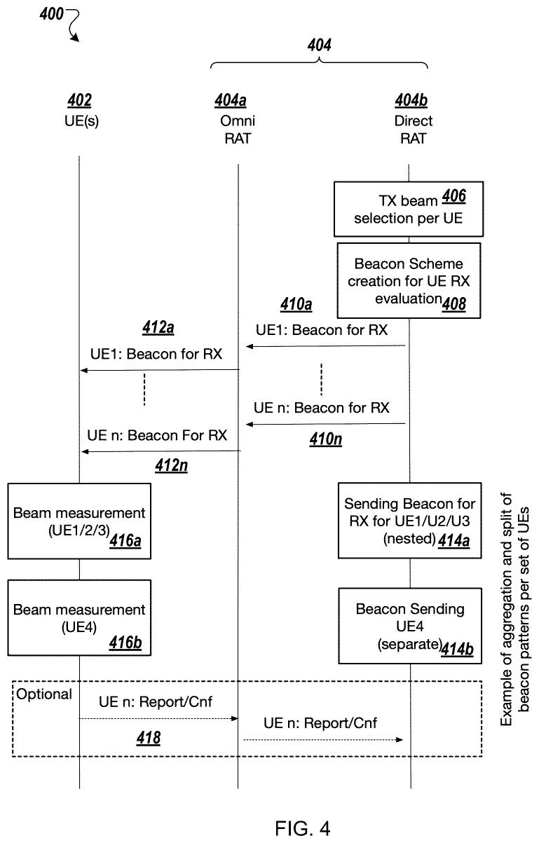

FIG. 4 depicts an example environment 400 in which two devices perform a reception (“Rx”) beam search, beam refinement, or both, procedure for a directional radio access technology (“RAT”). The two devices can include a wireless device 402, e.g., a user equipment, and an access point 404. The access point 404, such as the access point 202 described with reference to FIGS. 2A-B, can be any appropriate type of access point such as a cellular base station or an IEEE 802.11 access point, e.g., a Wi-Fi access point.

After finding the Tx beam 406, as described above with reference to FIGS. 2A-B and 3, the wireless device 402 can find a matching wireless device Rx beam. For instance, after the AP 404 finds the Tx beam 406 for each wireless device connection, e.g., the same beam or different beams, the AP 404 can transmit one or more beacons as part of the process by which the wireless device 402 selects a Rx beam.

In some implementations, the AP 404 does not require additional trigger, e.g., request, for the wireless device Rx beam selection procedure as the AP 404 is already aware of the wireless device 402 via the AP beacon request 206, e.g., for Tx selection. Given the report 244 from the UE that indicates the strongest strength Tx candidates, e.g., the best beams for the wireless device 402, the AP 404 is aware of the Tx beams that AP 404 will use for the wireless device Rx beam selection process. In some implementations, this set of Tx beams are spatially adjacent to each other.

Since the AP 404 has the set of Tx beams, the AP 404 can use one or more of these Tx beams for the wireless device Rx beam selection. As a result, the AP 404 does not need to transmit, and the wireless device 402 does not need to scan, all AP Tx beams. For instance, the AP 404 can use any appropriate process to select a best reported Tx beam, or a set of best reported Tx beams, identified by the report 244. The AP 404 can use the best reported Tx beam(s) for the wireless device Rx beam selection process. By using only a subset of all possible Tx beams, the wireless device 402, the AP 404, or both, can save computational resources compared to other systems in which all AP Tx beams are prolonged to be able to allow a wireless device Rx beam sweep.

In some implementations, the AP Tx beacon beams used for wireless device Rx beam selection can be transmitted for a longer time compared to the beams used for AP Tx selection. This can occur as the wireless device 402 needs to check several wireless device Rx beams during the AP Tx beam transmission.

In some implementations, the wireless device 402 can use data for the prior measurements of the AP Tx beams, e.g., described with reference to FIG. 2A, to select a set of Rx beams for analysis as part of the Rx beam selection process. For instance, based on the previously measured AP Tx beams, the wireless device 402 can have a coarse understanding of the to be expected AP beam direction, e.g., a predicted AP beam direction, and select the set of Rx beams using the expected, e.g., predicted, AP beam direction.

In some implementations, the AP 404 can use data about the wireless device 402 capabilities during wireless device Rx selection. For instance, the additional information in the beacon request 206 can include the data about the wireless device 402 capabilities for AP Tx direction detection, if any. The additional information can define the length of the AP 404 beacon for Rx selection used by the AP 404. In some implementations, the additional information can include an AP beam duration required by the wireless device 402 to scan a sufficient number of wireless device Rx beams.

The AP 404 can generate a reception beacon pattern 408 for wireless device Rx evaluation. The AP 404 can select the time and frequency grid for the reception beacon pattern 408. The AP 404 can use any appropriate process to generate the reception beacon pattern 408. For instance, the AP 404 can perform one or more operations described with reference to FIG. 4B to generate the reception beacon pattern 408. Since the AP 404 already received the beacon requests and created the request pool, the AP 404 need not repeat those operations. For example, the AP 404 can perform operations 222 through 234, as necessary, to generate the reception beacon pattern 408. In some implementations, during reception beacon pattern 408 generation, the AP can select a different procedure duration, beam duration, number of beams, or a combination of these, that are different than the corresponding values for the transmission beacon pattern. The number of beams for the reception beacon pattern can be fewer than the number of beams for the transmission beacon pattern. The beam duration for the reception beacon pattern can be longer than the beam duration for the transmission beacon pattern. The procedure duration for the reception beacon pattern can be longer than the procedure duration for the transmission beacon pattern.

In some implementations, for transmission gap usage during the wireless device Rx beam selection process, the AP 404 can form several AP Tx beams in parallel, via digital or analog beam forming, to be used by several wireless devices. This might result in a signal strength loss. In some implementations, as the reference signals are designed for omni-directional reception, any potential signal loss can be compensated by the directional wireless device reception.

The AP 404 can generate the beam pattern 408 for several wireless devices together to save additional resources. This can be a combination of two or more beams in the same time gap, e.g., as described above, usage or the same beam for several wireless devices, or a combination of both.

In some implementations, the AP 404 can combine the reception beacon pattern for Rx selection of the current wireless device pool, e.g., wireless device beacon request collection period n, with the transmission beacon pattern for Tx select of the next wireless device pool, e.g., wireless device beacon collection period n+1. In this way, the AP 404 can reduce resource usage by overlapping transmission of beams for wireless device Rx selection for a first wireless device with transmission of beams for Tx selection for a second, different wireless device using the same beacon pattern.

After creation of the reception beam pattern 408, the AP 404 can transmit the beacon pattern 410a-n to the corresponding wireless devices 402. The directional RAT AP 404b can send the reception beacon pattern 410a-n to the omni-directional RAT AP 404a. The omni-directional RAT AP 404a can forward the reception beacon pattern 412a-n to the corresponding wireless devices 402 that will use the pattern to select corresponding reception beams.

The AP can transmit one or more beacons 414a-b for the wireless devices 402. The wireless devices 402 can perform one or more beam measurements 416a-b. The wireless devices 402 can rotate their Rx beam 416a-b during the Tx beam transmission 414a-b and select the best Rx beam. The wireless device 402 can then select the best Rx beam, e.g., with the greatest strength or another parameter that indicates better performance than the other Rx beams measured.

The wireless device 402 can use the selected Rx beam to communicate with the AP 404, e.g., using the selected Tx beam for the AP 404. For instance, the currently best AP Tx beam and associated Rx beam are selected to start a data connection between wireless device 402 and the AP 404 using a directed connection. The data connection can use any appropriate data connection frequency resources and time resource.

In some implementations, the AP 404 might transmit, as part of the reception beam pattern, a separate Tx beacon for one of the wireless devices. This can occur when the one of the wireless devices selects a Tx beam for the AP 404 that satisfies a difference threshold compared to the Tx beams selected by the other wireless devices.

The wireless device, e.g., any of the wireless devices for the pool including the one of the wireless devices, can report 418 the selected Rx beam to the AP 404.

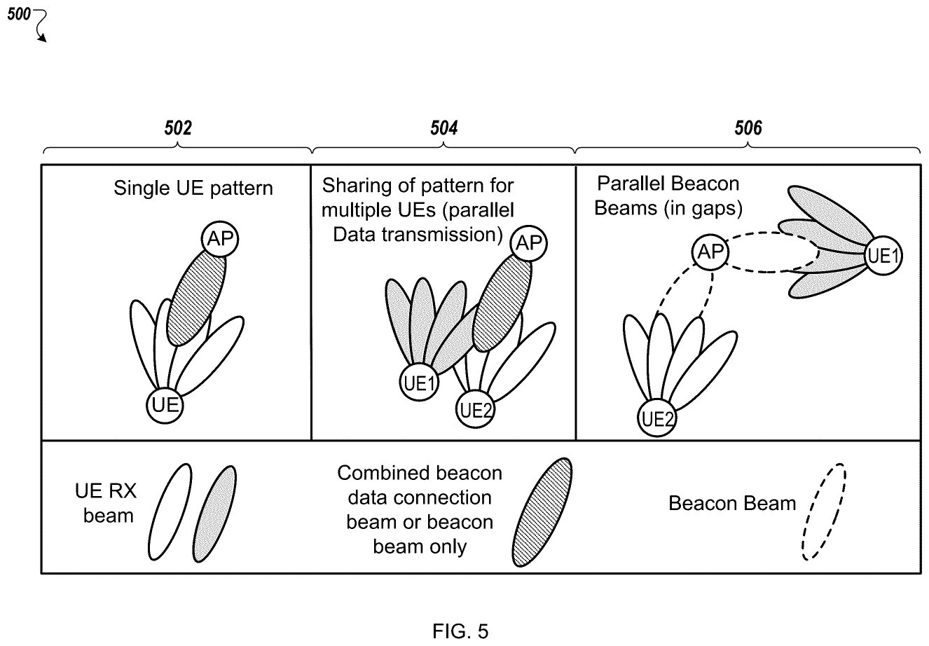

FIG. 5 depicts example beacon patterns 500. The patterns can be transmission beacon patterns, reception beacon patterns, or a combination of both. Specifically, the beacon patterns 500 can include a single wireless device pattern 502 in which an AP transmits a beam to a single wireless device during the wireless device Rx beam selection process. The beacon patterns 500 can include a sharing pattern 504 in which an AP transmits a beam to multiple wireless devices during the wireless device Rx beam selection process, e.g., as part of a parallel data transmission. The beacon patterns 500 can include a parallel beacon beam pattern 506 in which an AP transmits separate beams to separate wireless devices during the wireless device Rx beam selection process.

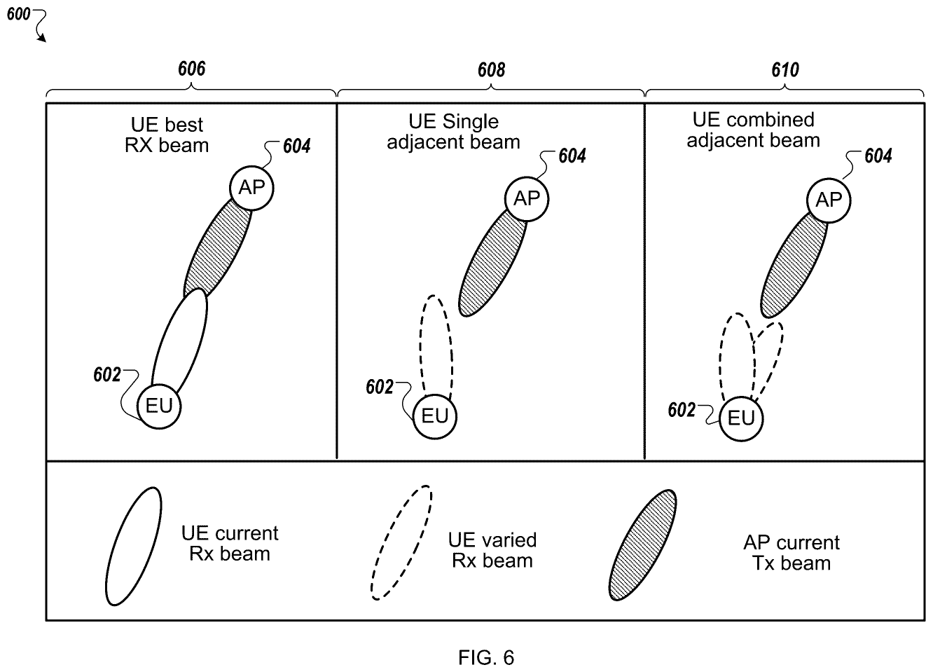

FIG. 6 depicts examples of beam alignment processes 600 during data transmission. For instance, during the data transmission, the wireless device 602 can move, rotate, or both. This can result in sub-optimal communication between the devices. For instance, to improve the connection between the devices after the wireless device 602 movement, rotation, or both, the AP 604 Tx beam, the wireless device 602 Rx beam, or both, can be adapted.

As a result, one or both of the AP 604 and the wireless device 602 can perform autonomous beam checks during the ongoing data connection. These beam checks can be autonomous in that the AP 604 and the wireless device 602 can separately perform the beam checks without communicating with the other device.

The devices 602-604 can perform the beam checks at any appropriate time. In some implementations, the AP 604 can perform transmit beam variation checks when the wireless device 602 is sending uplink (“UL”) frames. In some implementations, the wireless device 602 can perform receive beam variation checks when the AP 604 is sending downlink (“DL”) frames. As a result, in some implementations, beam variation checks and data sending can occur during overlapping time periods, e.g., always overlapping for the beam alignment procedure. In some implementations, the beam checks can be performed during transmission of ACK, NACK, or both, sent by a corresponding device.

The beam variation checks can be based on spatial considerations, e.g., a set of adjacent beams are checked. This can result in a corresponding device checking a limited number of beams, e.g., reducing resource usage, a limited degradation of the ongoing transmission due to beam misalignment, or both. By performing beam alignment during transmission, the wireless device 602, the access point 604, or both, can reduce an amount of this degradation, e.g., by switching to another beam.

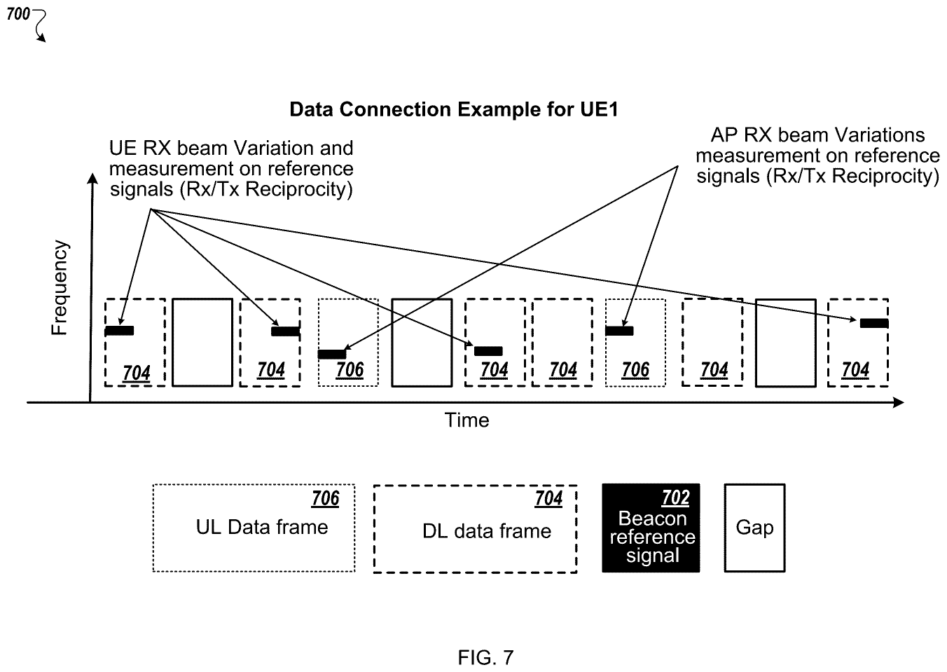

FIG. 7 depicts an example environment 700 in which a data connection includes multiple reference signals 702. The reference signals can be used for a beam variation check. The reference signals 702 can be used at any appropriate time. For instance, a device can include corresponding reference signals 702 in data transferred by the device according to a schedule. In some implementations, a device can change when the reference signals 702 are included in data transferred by the device.

In some implementations, an amount of time, frequency, or both, used for beam variation checks can satisfy, e.g., be less than, an amount threshold, e.g., 10% of the data slot. This can minimize the impact on the data reception, transmission, or both, compared to other systems. In some implementations, by using this amount of transmission resources, the loss in data for transmission can be compensated by data coding, protection and interleaving over the complete data slot, or both. During the time, frequency, or both, period used for beam variation checks, the corresponding device can use parts of the data signal for reference signals. For instance, the transmitting device, e.g., AP for DL data 704 or wireless device for UL data 706, can replace, e.g., puncture, some of the original data with a low bandwidth beacon reference signal 702. The receiving device, e.g., wireless device for DL data 704 or AP for UL data 706, can then analyze the corresponding beacon reference signals 702 to determine whether to change beams for the connection.

During the alignment process 606, the wireless device 602, can determine that it is using the best beam and to skip changing the beam for the connection.

During the alignment process 608, the wireless device 602 can determine to fully replace the current Rx beam with an adjacent Rx beam. This can occur when the Rx beams are overlapping, e.g., to a degree that satisfies an overlap threshold. In this case the data signal degradation can be small, although not using the originally best beam. In this alignment process 608, the wireless device 602 can directly detect the adjacent Rx beam to replace the originally best Rx beam.

During the alignment process 610, the wireless device 602 can determine to use a combination of Rx beams. The combination of Rx beams can be a combination of the best previously selected Rx beam and an adjacent Rx beam. The wireless device 602 can use this alignment process 610 when the Rx beam overlap does not satisfy the overlap threshold. In this case, fully switching to the adjacent beam might cause a data signal loss so the wireless device 602 uses the combination of the beams to reduce a likelihood of data signal loss. In some implementations, the combination of Rx beams can include a best beam x. The wireless device 602 can measure adjacent beams x+1 or x−1 to determine the best adjacent beam, resulting in indirectly detecting the best combination beam.

Similar processes can apply for the AP 604.

In some implementations, the time, frequency location, or both, of the beam variations is known to the wireless device and the AP and used to vary and measure the associated Rx beams.

In some implementations, the AP and the wireless device can autonomously change to the new best beams as soon as possible. In some implementations, no additional communication between AP and the wireless device is required.

In some implementations, one or both of the devices can optionally use, for beam variation checks, already available pilot symbols for data decoding, e.g., instead of additional pilots. This can further the signaling and pilot overhead, but might reduce the quality of the beam quality estimation.

In some implementations, the wireless device 602, the AP 604, or both, can determine a cadence of beam variation checks using any appropriate data. The data can include data indicating wireless device movement, wireless device rotation, a previous beam update rate, a connection signal quality, or a combination of two or more of these.

The wireless device movement data can indicate data captured by one or more sensors, e.g., an accelerometer, included on the wireless device. The sensors can enable the wireless device to detect movement, e.g., rapid movement, of the wireless device. Upon detecting wireless device movement, a corresponding device, e.g., the wireless device or the AP, can increase a cadence of beam variation checks, e.g., to handle the expected beam variation. The wireless device can forward the movement data, or data indicating wireless device movement without necessarily indicating the specific movement, to the AP, e.g., to trigger a cadence update by the AP.

The AP, the wireless device, or both, can use a previous beam variation rate. For instance, the AP and the wireless device can separately track the beam update rate and change, e.g., increase or decrease, the beam variation check cadence accordingly. In some implementations, due to different beam sizes on the wireless device and the AP, the cadences might differ.

As a subset of wireless device movement data, the cadence can be determined using wireless device rotation data, e.g., captured by a gyroscope included in the wireless device. As the wireless device rotates, the wireless device can measure its rotation at the wireless device side and select the new best Rx beam directly, e.g., assuming dominant LOS path. The wireless device can select the new best Rx beam in response to detecting rotation, e.g., without changing the beam variation check cadence. In some implementations, e.g., when the accuracy might vary, the wireless device can update of the beam variation check cadence in response to detecting wireless device rotation. In contrast to other types of movement, when the wireless device only rotates, the wireless device does not need to send rotation data to the AP since the AP Tx beam would not need to change given the wireless devices lack of change in physical position and only a change in rotation.

The cadence can change given different types of signal quality. For a first type of signal quality, there is good signal quality when there is a good beam alignment. As a result, a bigger wireless device movement can occur until a degradation happens. Thus, either or both of the devices can change, e.g., increase or decrease, their beam variation check cadence based on signal quality.

For a second type of signal quality, there is good signal quality when parts of the signal protection, e.g., via ⅓ Turbo coding, provides more redundancy than required, e.g., assuming a limited coding scheme variation. A device can use this signal protection to increase the number of beam variations within a single slot allowed, e.g., minimizing the effect of or without affecting the data transmission quality.

For a third type of signal quality, a device can chance the cadence when there is a steep signal quality change.

In some implementations, the wireless device 602 can provide data for the wireless device to the AP 604, which data the AP 604 can use to determine the cadence of the AP's beam check. As a result, the AP 604 can use data from the wireless device 602 to determine when to perform a beam check while performing the beam check, and any corresponding changes, autonomously.

In some implementations, when either of the devices uses data symbol puncturing by beacon signals or usage of data pilots instead of dedicated beacon pilots, the cadence of the AP, the wireless device, or both, beam variation checks does not have to be exchanged between the wireless device and the AP and can be chosen independently.

In some implementations, the wireless device and the AP can exchange data about their respective beam variation check cadence. This can cause the two devices to have more similar, or the same, cadence checks, e.g., when the wireless device rotates, moves at a speed that satisfies a speed threshold, or a combination of both. In case rate matching around additional beacon signals is used within the data signals, data identifying the cadence, the resources, or both, can be communicated between the AP and the wireless device. This data can include one or more of the following: i) data that identifies which UL or DL frame used for beam variations. e.g., time-map or number of UL/DL frames between variations; ii) data that identifies which portions within the data transmission are used for beam variations; or iii) data that identifies a reference to a predefined table, e.g., an entry in the table for corresponding cadence information. When using a reference to the predefined table, in some implementations the two devices might not be able to autonomously change the cadence, e.g., the cadence of both devices is the same and changes together. In some implementations, the AP might be responsible for aligning and updating the measurement patterns, e.g., if required. In some implementations, a device, e.g., the wireless device or the AP, can send one or more update events towards the other device, e.g., via the omni-directional RAT or in-band signaling. The device can send the update events on thresholds or time events. In some implementations, whenever a new event arrives at the AP, e.g., wireless device-based or AP based, the AP can evaluate the currently used beam variation check and determine whether updates are required. If so, the AP can send the updates towards the UE(s).

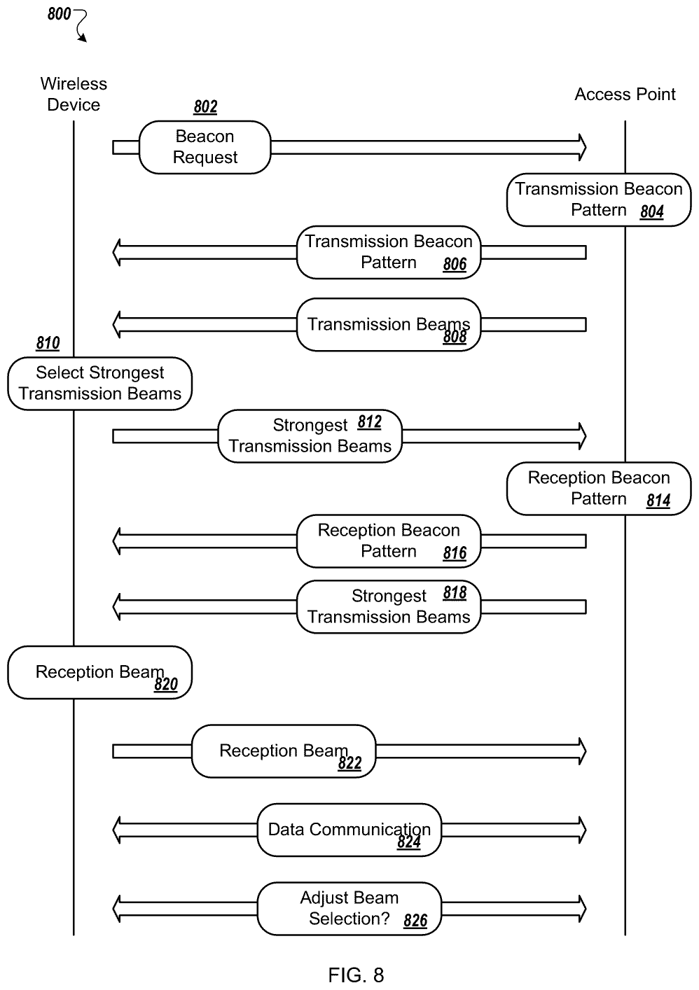

FIG. 8 illustrates a swim lane diagram of an example method 800 for using a beacon pattern, according to some implementations. For clarity of presentation, the description that follows generally describes method 800 in the context of the other figures in this description. For example, various operations of the method 800 can be performed by a device, e.g., the wireless device or the access point, of FIGS. 2A-B, 3-5. It will be understood that method 800 can be performed, for example, by any suitable system, environment, software, hardware, or a combination of systems, environments, software, and hardware, as appropriate. In some implementations, various operations of method 800 can be run in parallel, in combination, in loops, or in any order.

A device, e.g., a wireless device, can transmit 802 a beacon request to an access point. The access point can receive 802 the beacon request.

The access point can generate 804 a transmission beacon pattern.

The access point can transmit 806 the transmission beacon pattern to the device. The device can receive 806 the transmission beacon pattern.

The access point can transmit 808 one or more transmission beams according to the transmission beacon pattern. The device can receive signals for at least some of the transmission beams and select 810 one or more strongest transmission beams.

The device can transmit 812 data that identifies the one or more strongest transmission beams to the access point. The access point can receive 812 the data that identifies the one or more strongest transmission beams.

The access point can generate 814 a reception beacon pattern, e.g., based at least on the one or more strongest transmission beams, data for the device, or both.

The access point can transmit 816 the reception beacon pattern to the device. The device can receive 816 the reception beacon pattern.

The access point can transmit 818 at least one of the one or more strongest transmission beams according to the reception beacon pattern. The device can receive signals for at least some of the one or more strongest transmission beams and select 820 a reception beam.

The device can optionally transmit 822 data that identifies the reception beam to the access point. The access point can optionally receive 822 the data that identifies the reception beam.

The access point and the device can communicate 824 using the one of the one or more strongest transmission beams and the reception beam. For instance, the access point and the device can communicate uplink data, downlink data, control data, or a combination of these.

In some implementations, while the two devices are communicating 824, one or both of the devices can determine whether to adjust 824 a beam selection. This can include the access point determining whether to adjust the strongest transmission beam, the device determining whether to adjust the reception beam, or a combination of both.

The example method 800 shown in FIG. 8 can be modified or reconfigured to include additional, fewer, or different operations (not shown in FIG. 8), which can be performed in the order shown or in a different order. For instance, the method 800 need not include the operations performed by the other device, e.g., the method can include only the operations performed by the device or only the operations performed by the access point. In some implementations, the method 800 need not include the reception beam communication 822, the beam selection adjustment 826, or both.

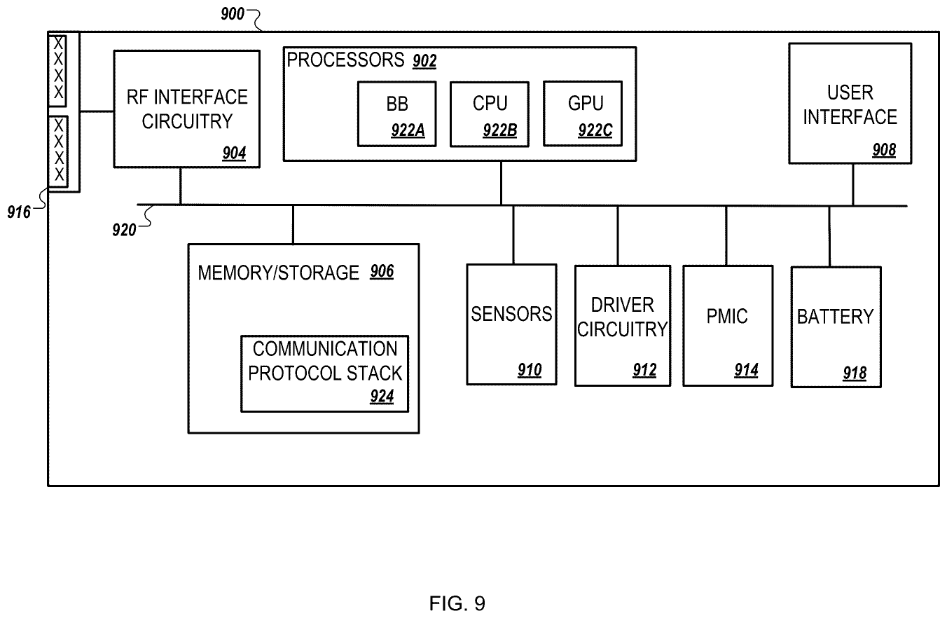

FIG. 9 illustrates an example UE 900, according to some implementations. The UE 900 may be similar to and substantially interchangeable with UE 102 of FIG. 1.

The UE 900 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 900 may include processors 902, RF interface circuitry 904, memory/storage 906, user interface 908, sensors 910, driver circuitry 912, power management integrated circuit (PMIC) 914, one or more antenna(s) 916, and battery 918. The components of the UE 900 may be implemented as integrated circuits (ICs), portions thereof, discrete electronic devices, or other modules, logic, hardware, software, firmware, or a combination thereof. The block diagram of FIG. 9 is intended to show a high-level view of some of the components of the UE 900. However, some of the components shown may be omitted, additional components may be present, and different arrangement of the components shown may occur in other implementations.

The components of the UE 900 may be coupled with various other components over one or more interconnects 920, which may represent any type of interface, input/output, bus (local, system, or expansion), transmission line, trace, optical connection, etc. that allows various circuit components (on common or different chips or chipsets) to interact with one another.

The processors 902 may include processor circuitry such as, for example, baseband processor circuitry (BB) 922A, central processor unit circuitry (CPU) 922B, and graphics processor unit circuitry (GPU) 922C. The processors 902 may include any type of circuitry or processor circuitry that executes or otherwise operates computer-executable instructions, such as program code, software modules, or functional processes from memory/storage 906 to cause the UE 900 to perform operations as described herein.

In some implementations, the baseband processor circuitry 922A may access a communication protocol stack 924 in the memory/storage 906 to communicate over a 3GPP compatible network. In general, the baseband processor circuitry 922A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 904. The baseband processor circuitry 922A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 906 may include one or more non-transitory, computer-readable media that includes instructions (for example, communication protocol stack 924) that may be executed by one or more of the processors 902 to cause the UE 900 to perform various operations described herein. The memory/storage 906 include any type of volatile or non-volatile memory that may be distributed throughout the UE 900. In some implementations, some of the memory/storage 906 may be located on the processors 902 themselves (for example, L1 and L2 cache), while other memory/storage 906 is external to the processors 902 but accessible thereto via a memory interface. The memory/storage 906 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 904 may include transceiver circuitry and radio frequency front module (RFEM) that allows the UE 900 to communicate with other devices over a radio access network. The RF interface circuitry 904 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna(s) 916 and proceed to filter and amplify (with a low-noise amplifier) the signal. The signal may be provided to a receiver of the transceiver that downconverts the RF signal into a baseband signal that is provided to the baseband processor of the processors 902.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna(s) 916. In various implementations, the RF interface circuitry 904 may be configured to transmit/receive signals in a manner compatible with NR access technologies.

The antenna(s) 916 may include one or more antenna elements to convert electrical signals into radio waves to travel through the air and to convert received radio waves into electrical signals. The antenna elements may be arranged into one or more antenna panels. The antenna(s) 916 may have antenna panels that are omnidirectional, directional, or a combination thereof to enable beamforming and multiple input, multiple output communications. The antenna(s) 916 may include microstrip antennas, printed antennas fabricated on the surface of one or more printed circuit boards, patch antennas, phased array antennas, etc. The antenna(s) 916 may have one or more panels designed for specific frequency bands including bands in FR1 or FR2.

The user interface 908 includes various input/output (I/O) devices designed to enable user interaction with the UE 900. The user interface 908 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 900.

The sensors 910 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 912 may include software and hardware elements that operate to control particular devices that are embedded in the UE 900, attached to the UE 900, or otherwise communicatively coupled with the UE 900. The driver circuitry 912 may include individual drivers allowing other components to interact with or control various input/output (I/O) devices that may be present within, or connected to, the UE 900. For example, driver circuitry 912 may include a display driver to control and allow access to a display device, a touchscreen driver to control and allow access to a touchscreen interface, sensor drivers to obtain sensor readings of sensors 910 and control and allow access to sensors 910, drivers to obtain actuator positions of electro-mechanic components or control and allow access to the electro-mechanic components, a camera driver to control and allow access to an embedded image capture device, audio drivers to control and allow access to one or more audio devices.

The PMIC 914 may manage power provided to various components of the UE 900. In particular, with respect to the processors 902, the PMIC 914 may control power-source selection, voltage scaling, battery charging, or DC-to-DC conversion.

In some implementations, the PMIC 914 may control, or otherwise be part of, various power saving mechanisms of the UE 900. A battery 918 may power the UE 900, although In some implementations the UE 900 may be mounted deployed in a fixed location, and may have a power supply coupled to an electrical grid. The battery 918 may be a lithium ion battery, a metal-air battery, such as a zinc-air battery, an aluminum-air battery, a lithium-air battery, and the like. In some implementations, such as in vehicle-based applications, the battery 918 may be a typical lead-acid automotive battery.

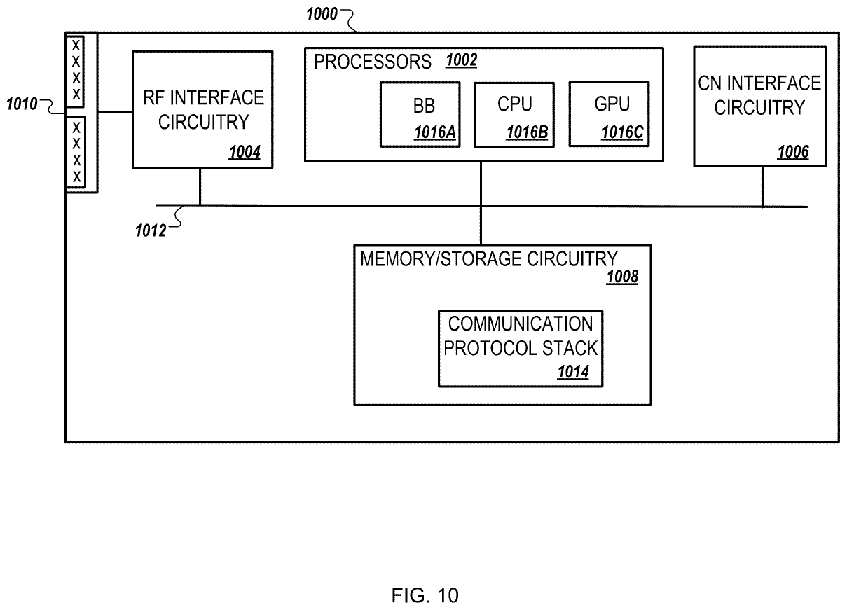

FIG. 10 illustrates an example access node 1000 (e.g., a base station or gNB), according to some implementations. The access node 1000 may be similar to and substantially interchangeable with base station 104. The access node 1000 may include processors 1002, RF interface circuitry 1004, core network (CN) interface circuitry 1006, memory/storage circuitry 1008, and one or more antenna(s) 1010.

The components of the access node 1000 may be coupled with various other components over one or more interconnects 1012. The processors 1002, RF interface circuitry 1004, memory/storage circuitry 1008 (including communication protocol stack 1014), antenna(s) 1010, and interconnects 1012 may be similar to like-named elements shown and described with respect to FIG. 9. For example, the processors 1002 may include processor circuitry such as, for example, baseband processor circuitry (BB) 1016A, central processor unit circuitry (CPU) 1016B, and graphics processor unit circuitry (GPU) 1016C.

The CN interface circuitry 1006 may provide connectivity to a core network, for example, a 5th Generation Core network (5GC) using a 5GC-compatible network interface protocol such as carrier Ethernet protocols, or some other suitable protocol. Network connectivity may be provided to/from the access node 1000 via a fiber optic or wireless backhaul. The CN interface circuitry 1006 may include one or more dedicated processors or FPGAs to communicate using one or more of the aforementioned protocols. In some implementations, the CN interface circuitry 1006 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 1000 that operates in an NR or 5G system (for example, a gNB), and the term “E-UTRAN node” or the like may refer to an access node 1000 that operates in an LTE or 4G system (e.g., an eNB). According to various implementations, the access node 1000 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 1000 may be implemented as one or more software entities running on server computers as part of a virtual network, which may be referred to as a CRAN and/or a virtual baseband unit pool (vBBUP). In V2X scenarios, the access node 1000 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A method comprising:
receiving, from a device, a beacon request;
generating a transmission beacon pattern associated with the beacon request;
transmitting a plurality of beams according to the transmission beacon pattern;
receiving a message that identifies one or more strongest transmission beams of the plurality of beams;
generating a reception beacon pattern associated with the beacon request;
transmitting the one or more strongest transmission beams according to the reception beacon pattern; and
communicating, with the device, using at least one of the one or more strongest transmission beams and a reception beam of the device.

2. The method of claim 1, wherein:
receiving the beacon request is performed using an omni-directional radio access technology; and
transmitting the plurality of beams and the one or more strongest transmission beams is performed using a directional radio access technology.

3. The method of claim 1, comprising transmitting, to the device, the transmission beacon pattern or the reception beacon pattern using an omni-directional radio access technology.

4. The method of claim 1, wherein the transmission beacon pattern is generated based on an item of information associated with the device.

5. The method of claim 4, comprising:
receiving, from each device in a plurality of devices including the device, a corresponding beacon request that comprises information associated with the corresponding device, wherein the transmission beacon pattern is generated using information associated with two or more devices in the plurality of devices.

6. The method of claim 1, wherein the reception beacon pattern is generated based on an item of information associated with the device.

7. The method of claim 1, wherein:
generating a beacon pattern comprises identifying a gap in scheduled data communications; and
transmitting a beam according to the transmission beacon pattern or the reception beacon pattern comprises puncturing or rate matching around the scheduled data communications for a beacon reference signal transmission.

8. The method of claim 1, wherein:
the transmission beacon pattern associated with the beacon request comprises a defined start point; and
transmitting the plurality of beams comprises transmitting a first beam of the plurality of beams in accordance with the defined start point.

9. The method of claim 1, wherein generating the reception beacon pattern comprises generating a beacon pattern for the device to select a corresponding reception beam and a second, different device to select one or more strongest transmission beams.

10. The method of claim 1, comprising:
while communicating with the device:
determining whether to adjust a transmission beam for the communication with the device; and
selectively adjusting the transmission beam or determining to skip adjusting the transmission beam based at least in part on a result of the determination of whether to adjust the transmission beam for the communication with the device.

11. The method of claim 1, wherein the reception beam associated with the device is based at least on the reception beacon pattern.

12. A method comprising:
transmitting, to an access point, a beacon request;
receiving first data identifying a transmission beacon pattern associated with the beacon request;
selecting, from a plurality of beams transmitted according to the transmission beacon pattern, one or more strongest transmission beams;
transmitting, to an access point, data identifying the one or more strongest transmission beams;
based at least on transmitting the data identifying the one or more strongest transmission beams, receiving second data identifying a reception beacon pattern associated with the beacon request;
selecting, based at least on transmission of the one or more strongest transmission beams according to the reception beacon pattern, a reception beam; and
communicating, with the access point, using at least one of the one or more strongest transmission beams and the reception beam.

13. The method of claim 12, wherein:
transmitting the beacon request is performed using an omni-directional radio access technology; and
selecting the one or more strongest transmission beams and selecting the reception beam are performed using a directional radio access technology.

14. The method of claim 12, comprising:
while communicating with the access point:
determining whether to adjust a reception beam associated with the communication with the access point; and
selectively adjusting the reception beam or determining to skip adjusting the reception beam based on a result of the determination of whether to adjust the reception beam associated with the communication with the access point.

15. The method of claim 14, comprising determining a cadence with which to determine whether to adjust the reception beam associated with the communication with the access point.

16. The method of claim 15, wherein the cadence is determined based at least on one or more of device movement data, device rotation data, a prior beam variation rate, or a signal quality.

17. The method of claim 12, wherein:
transmitting the beacon request comprises transmitting, by a wireless device and to the access point, the beacon request.

18. An access point comprising one or more processors configured to perform operations comprising:
receiving, from a device, a beacon request;
generating a transmission beacon pattern associated with the beacon request;
transmitting a plurality of beams according to the transmission beacon pattern;
receiving a message that identifies one or more strongest transmission beams of the plurality of beams;
generating a reception beacon pattern associated with the beacon request;
transmitting the one or more strongest transmission beams according to the reception beacon pattern; and
communicating, with the device, using at least one of the one or more strongest transmission beams and a reception beam of the device.

19. The access point of claim 18, wherein:
receiving the beacon request is performed using an omni-directional radio access technology; and
transmitting the plurality of beams and the one or more strongest transmission beams is performed using a directional radio access technology.

20. The access point of claim 18, the operations comprising transmitting, to the device, the transmission beacon pattern or the reception beacon pattern using an omni-directional radio access technology.
